(19) United States
(12) Patent Application Publication
(10) Pub. No.: US 2007/0292109 A1
(43) Pub. Date: Dec. 20, 2007

(54) Method of and apparatus for reproducing compression encoded video data stream

(75) Inventors: Jin-hyeon Chol, Seoul (KR); Jeong-hun Park, Yongin-si (KR); Jin-min Kim, Seoul (KR); Yang-ju Lee, Seoul (KR); Young-Joon Ahn, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/604,351

(22) Filed: Nov. 27, 2006

(30) Foreign Application Priority Data
Jun. 15, 2006 (KR) 2006-53891

(51) Int. Cl. H04N 5/91

(52) U.S. Cl. 386/68

(57) ABSTRACT

A method of reproducing a compression-encoded video data stream includes receiving an input point of time at which a user desires a reproduction operation, determining the type of a picture frame corresponding to the input point of time, extracting a reference frame required for decoding the picture frame corresponding to the input point of time according to the determined type of the picture frame, and decoding the picture frame corresponding to the input point of time using the extracted reference frame and outputting the decoded picture frame.

### CROSS-REFERENCE TO RELATED APPLICATIONS

This application claims the benefit of Korean Patent Application No. 2006-53891, filed on Jun. 15, 2006, in the Korean Intellectual Property Office, the disclosure of which is incorporated herein in its entirety by reference.

### BACKGROUND OF THE INVENTION

1. Field of the Invention

Aspects of the present invention relate to a method of reproducing a compression-encoded video data stream, and more particularly, to a method and apparatus by which the output of and fast search for a video data stream can be implemented in a media player at a specific point of time.

2. Description of the Related Art

According to a conventional method for reproducing a compression-encoded video data stream, in order to decode and reproduce intra (I) pictures, predictive (P) pictures, and bidirectional predictive (B) pictures included in a group of pictures (GOP), the reproduction and output of a video are performed based on the I pictures. This is because encoded video data is generated based on past and future picture data and information is not completed with a single picture in a moving picture experts group (MPEG) system. However, since an I picture has complete information with a sheet of picture data without using information of past and future pictures, it can be reproduced without using information of another picture and data of another picture can be reproduced using the I picture. The I picture is a type of picture that guarantees independency of a GOP. Due to the I picture, a random access can be made in units of a GOP having several sheets of picture data. Thus, according to the conventional method, even when it is desired to output a picture at an accurate location corresponding to a specific point of time, only an I picture frame that is most temporally adjacent to the specific point of time is output. As a result, when a user desires to execute a fast forward search and a reverse search in units of one minute, for example, such operations are not supported.

FIG. 1 is a flowchart illustrating a conventional fast rewind method.

Referring to FIG. 1, the conventional fast rewind method includes determining in operation 100 that fast rewind is selected; performing another function in operation 150 if fast rewind is not selected by a user's key manipulation; if fast rewind is selected in operation 100, extracting packets, which range from a current offset to a picture start code of a next frame, from a program stream storing unit by using an index value that approximates closest to the current offset and is found in an index storing unit by an index searching unit, and displaying the extracted packets in operation 110; moving to a location having a past I frame using a next entry index value of the index storing unit, found by the index searching unit and extracting and displaying the past I frame in operation 120; determining whether another function is selected in operation 130; if another function is selected, performing a corresponding function in operation 140; and if another function is not selected, repeating operation 120.

According to the rewind method, the index storing unit receives an index value of a start portion of a packet having a picture start code of an I frame in a video stream through a program stream demultiplexer and decoder and stores the received index value and, if fast rewind is required, the program stream storing unit extracts and displays only the I frame. In other words, a program stream extracting unit extracts an MPEG program stream stored in the program stream storing unit using an index value, which is stored in the index storing unit, of a start portion of a packet having a picture start code of an I frame in a video stream and the extracted MPEG program stream is reproduced during fast rewind.

Thus, according to the conventional method of reproducing a compression-encoded video data stream, reproduction and output are performed based on an I picture frame during forward playback as well as fast rewind. As a result, it is not possible to output a picture frame at an accurate location corresponding to an accurate time desired by a user.

### SUMMARY OF THE INVENTION

Aspects of the present invention provide a method and apparatus by which a picture corresponding to an input point of time at which the user desires to output the picture can be reproduced and by which a P picture frame or a B picture frame as well as an I picture frame can be output. The method and apparatus can also be applied to a fast search (fast forward and rewind).

According to one aspect of the present invention, there is provided a method of reproducing a compression-encoded video data stream. The method includes receiving an input point of time at which a user desires a reproduction operation, determining the type of a picture frame corresponding to the input point of time, extracting a reference frame required for decoding the picture frame corresponding to the input point of time according to the determined type of the picture frame, and decoding the picture frame corresponding to the input point of time using the extracted reference frame and outputting the decoded picture frame.

According to another aspect of the present invention, there is provided a method of fast searching for a compression-encoded video data stream. The method includes receiving a desired search time unit, determining the type of a picture frame corresponding to the received search time unit, extracting a reference frame required for decoding the picture frame corresponding to the search time unit according to the determined type of the picture frame, and decoding the picture frame corresponding to the search time unit using the extracted reference frame and outputting the decoded picture frame.

According to another aspect of the present invention, there is provided an apparatus for reproducing a compression-encoded video data stream. The apparatus includes an input unit, a control unit, an extraction unit, and an output unit. The input unit receives an input point of time at which a user desires a reproduction operation. The control unit determines the type of a picture frame corresponding to the input point of time. The extraction unit extracts a reference frame required for decoding the picture frame corresponding to the input point of time according to the determined type of the picture frame. The output unit decodes the picture frame corresponding to the input point of time using the extracted reference frame and outputting the decoded picture frame.

According to another aspect of the present invention, there is provided an apparatus for fast searching for a compression-encoded video data stream. The apparatus includes an input unit, a control unit, an extraction unit, and an output unit. The input unit receives a desired search time unit. The control unit determines the type of a picture frame corresponding to the received search time unit. The extraction unit extracts a reference frame required for decoding the picture frame corresponding to the search time unit according to the determined type of the picture frame. The output unit decodes the picture frame corresponding to the search time unit using the extracted reference frame and outputs the decoded picture frame.

According to another aspect of the present invention, there is provided a method of fast searching in a compression-encoded video data stream, the method comprising: receiving a selected input point of time, a selected unit search time and a selected direction of search; determining the type of picture frame corresponding to the selected input point of time; extracting a reference frame required for decoding the picture frame corresponding to the selected input point of time according to the determined type of picture frame; decoding the picture frame corresponding to the selected input point of time using the extracted reference frame and outputting the decoded picture frame; calculating a new input point of time by adding or subtracting the unit search time according to the direction of search, and repeatedly receiving a calculated input point of time, determining the type of picture frame corresponding to the calculated input point of time, extracting a reference frame required for decoding the picture frame corresponding to the calculated input point of time according to the determined type of picture frame; decoding the picture frame corresponding to the calculated input point of time using the extracted reference frame and outputting the decoded picture frame; and calculating a new input point of time by adding or subtracting the unit search time according to the direction of search until the fast searching is completed.

According to another aspect of the present invention, there is provided an apparatus for fast searching for a compression-encoded video data stream, the apparatus comprising: an input unit to receive a input point of time, a selected unit search time and a selected direction of search; a control unit to determine the type of picture frame corresponding to the received input point of time; an extraction unit to extract a reference frame required for decoding the picture frame corresponding to the received input point of time according to the determined type of picture frame; and an output unit to decode the picture frame corresponding to the received input point of time using the extracted reference frame, to output the decoded picture frame, and to calculate and output to the input unit a new input point of time based on the selected unit search time and selected direction of search.

According to another aspect of the present invention, there is provided a computer-readable recording medium having recorded thereon a program for implementing the method of reproducing a compression-encoded video data stream and the method of fast searching for a compression-encoded video data stream.

According to another aspect of the present invention, there is provided a computer data signal embodied in a carrier wave comprising a computer readable code implementing the method of reproducing a compression-encoded video data stream and the method of fast searching for a compression-encoded video data stream.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a conventional fast rewind method;

FIG. 2 is a flowchart illustrating a method of reproducing a compression-encoded video data stream according to an embodiment of the present invention;

FIG. 3A is a flowchart illustrating a method of reproducing a compression-encoded video data stream according to another embodiment of the present invention;

FIG. 3B is a flowchart illustrating a method of reproducing a compression-encoded video data stream according to another embodiment of the present invention;

FIG. 4 illustrates the structure of vop_coding_type indicating the type of a picture frame;

FIG. 5A is a representation for comparing the order of picture frames in a reproducing order and the order of picture frames in a decoding order;

FIG. 5B is another representation for comparing the order of picture frames in a reproducing order and the order of picture frames in a decoding order;

FIG. 6 is a flowchart illustrating a method of reproducing a compression-encoded video data stream according to another embodiment of the present invention;

FIG. 7 is a flowchart illustrating a method of fast searching for a compression-encoded video data stream according to an embodiment of the present invention;

FIG. 8 is a block diagram of an apparatus for reproducing a compression-encoded video data stream according to an embodiment of the present invention;

FIG. 9 is a detailed block diagram of a control unit illustrated in FIG. 8 according to an embodiment of the present invention;

FIG. 10 is a detailed block diagram of an extraction unit and an output unit illustrated in FIG. 8 according to an embodiment of the present invention; and

FIG. 11 is a detailed block diagram of an extraction unit and an output unit illustrated in FIG. 8 according to another embodiment of the present invention.

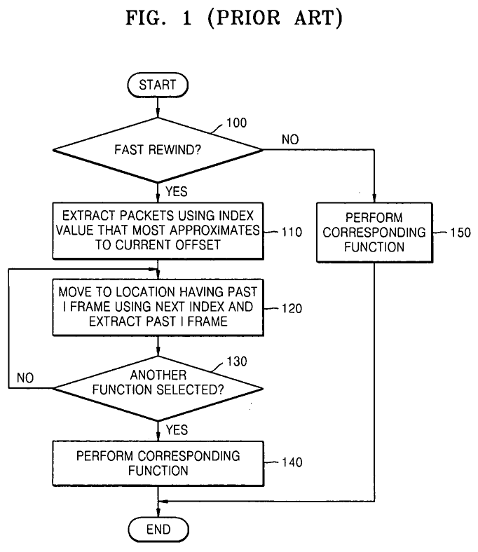

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

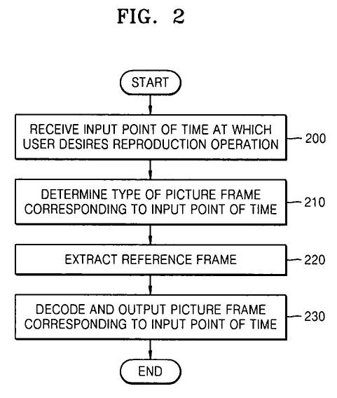

FIG. 2 is a flowchart illustrating a method of reproducing a compression-encoded video data stream according to an embodiment of the present invention.

Referring to FIG. 2, the method includes receiving an input point of time at which a user desires a reproduction operation in operation 200, determining the type of a picture frame corresponding to the input point of time in operation 210, extracting a reference frame required to decode the picture frame corresponding to the input point of time according to the determined type of the picture frame in operation 220, and decoding the picture frame corresponding to the input point of time using the extracted reference frame and outputting the decoded picture frame in operation 230.

In operation 200, the input point of time at which the user desires a reproduction or output operation on a video data stream is received. In this operation, the input point of time time required for reproducing, outputting, or printing a specific picture corresponding to the time is input through various digital devices such as a personal digital assistant (PDA), a notebook, a portable terminal, a portable multimedia player (PMP), or a video printer.

In operation 210, the type of the picture frame corresponding to the input point of time is determined. In a moving picture experts group (MPEG) system, picture frames constituting a group of pictures (GOP) include three types of pictures, i.e., intra (I) pictures, predictive (P) pictures, and bidirectional-predictive (B) pictures. The I picture is obtained by independent encoding in itself regardless of past and future pictures. In other words, motion estimation in a temporal direction is not applied to the I picture and the I picture can be encoded using only information within itself. The P picture is obtained by forward predictive encoding between pictures. In other words, encoding is performed using an interframe prediction with an I picture or a P picture as a prediction picture. However, only forward (unidirectional) prediction using a macroblock of a temporally past frame of the current frame can be applied for prediction of a macroblock of the current frame. The B picture is obtained by predictive encoding in both past and future directions. In other words, a block is predicted from a past reference block and a future reference block using an I picture or a P picture as a prediction picture. It is possible to perform bidirectional prediction using a macroblock in a past direction, a future direction, or both of them with respect to the current frame on a time axis.

In other words, the I picture frame is an intra encoding frame (a frame to be encoded using information within itself), the P picture frame is a predictive encoding frame (a frame to be forward predictive-encoded using information between frames), and the B picture frame is a bidirectionally predictive-encoding frame (a frame to be bidirectionally predictive-encoded). Thus, the type of a corresponding picture frame is determined, and whether and how to extract a reference frame required for prediction during decoding varies according to the determined type of the picture frame.

In operation 220, a reference frame is extracted. If the type of the picture frame is determined to be a P picture frame in operation 210, since forward (unidirectional) prediction is used that encodes the P picture frame by interframe prediction using an I picture or a P picture as a prediction picture and uses a macroblock in a past frame of the P picture frame on the time axis, a past I picture frame is extracted. Since motion estimation in a temporal direction is not applied to an I picture frame and since the I picture frame can be encoded using only information within itself, the I picture frame is selected as a reference frame. If the type of the picture frame is determined to be a B picture frame in operation 210, since bidirectional prediction is used that predicts a block from a past reference block and a future reference block using an I picture or a P picture as a prediction picture, i.e., using a macroblock in a past direction, a future direction, or both with respect to the current frame on a time axis, a past I picture frame and a future I picture frame or P picture frame are extracted as reference frames.

In operation 230, the picture frame corresponding to the input point of time is predictive-decoded using the reference frame(s) and is output. For example, if the type of the picture frame corresponding to the input point of time is a B picture frame, a past I picture frame and a future I picture frame or P picture frame are extracted as reference frames and the B picture frame is decoded for reproduction using the extracted reference frames. If the type of the picture frame corresponding to the input point of time is a P picture frame, only a past I picture frame is extracted and the P picture frame is decoded for reproduction using the extracted reference frame. If the type of the picture frame corresponding to the input point of time is an I picture frame, the I picture frame is extracted and output.

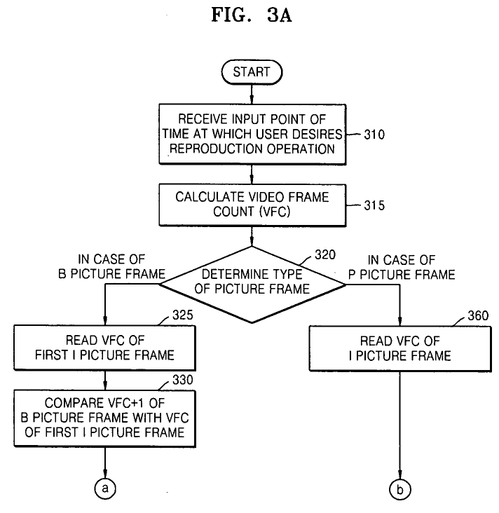

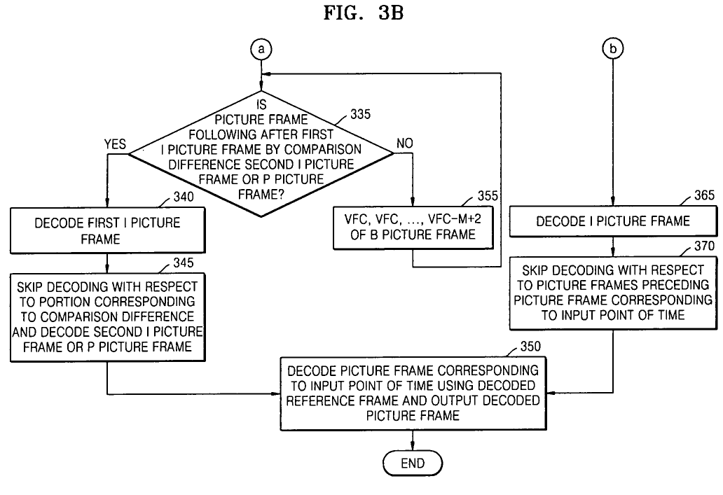

FIGS. 3A and 3B are flowcharts illustrating a method of reproducing a compression-encoded video data stream according to another embodiment of the present invention. Although the flowcharts constitute one method, they are illustrated separately in FIG. 3A and FIG. 3B on account of limited space.

In operation 310, an input point of time at which a user desires a reproduction or output operation on a video data stream is received. For example, if the input point of time is 2 minutes and 30 seconds, it may be input from the user or may be specified using a control device of a video output system.

In operation 315, a video frame count (VFC) corresponding to the input point of time is calculated. Since the input point of time is expressed by a time unit (sec) and the unit of processing of a system is a frame count, conversion between those units is required as follows:

targetVidCnt=(timeStamp*pm→ticksPerSec[pm→videoTrack]/(pm→ticksPerFrame[pm→videoTrack]*1000.0) (1),

where targetVidCnt is a VFC to be calculated, timestamp is an input point of time, pm is a program memory pointer, videoTrack is a delimiter of a currently reproduced video data stream, ticksPerSec is the number of system clock ticks per second, and ticksPerFrame is the number of system clock ticks per frame. Appropriate adjustments can be made if the time unit is smaller than seconds. For Example, if the unit of the input point of time is 1/1000 second (ms), it is made identical to the unit of processing by being multiplied by 1000.0.

Using the conversion equation, the input point of time is converted into a VFC of a specific picture (picture frame) corresponding to the input point of time for calculation.

In operation 320, a picture frame corresponding to the input point of time is searched for in picture frames included in the video data stream using the VFC calculated in operation 315 and the type of the found picture frame is determined. If the type of the found picture frame is determined to be an I picture frame, it is an intra picture and thus can be obtained by independent encoding within itself regardless of a past or future picture. As a result, the I picture frame is decoded and output without the need for extraction of a reference frame. Therefore, it is not necessary to describe the outputting of an I picture frame in detail.

In operation 325, if the type of the found picture frame is determined to be a B picture frame in operation 320, a VFC of a past I picture frame is read to extract a past reference frame. The past I picture frame that is closest to the B picture frame is selected using index information included in the video data stream to be reproduced.

In operation 330, a comparison difference between a result (VFC+1) of adding 1 to the VFC of the picture frame corresponding to the input point of time and the VFC of the I picture frame (hereinafter, referred to as a first I picture frame) read in operation 325 is obtained.

In operation 335, it is checked if a picture frame following after the first I picture frame by the comparison difference calculated in operation 330 is an I picture frame (hereinafter, referred to as a second I picture frame) or a P picture frame. This is intended to read the VFC of a past second I picture frame or a P picture frame that is closest to the B picture frame in a decoding order.

When it is checked if the picture frame is the second I picture frame or the P picture frame, determination of the type of the picture frame can be calculated by an AND operation and a shift operation using a vop_coding_type indicating the type of the picture frame included in the video data stream and data information indicating 1-byte data after 4 bytes from a start point of a start code of the picture frame, as follows:

vop_coding_type=(data&0xC0)>>6 (2)

In operation 355, if the picture frame following after the first I picture frame by the calculated comparison difference is not an I picture frame or a P picture frame in operation 335, the VFC of the B picture frame corresponding to the input point of time, VFC−1, . . . , VFC−M+2 are sequentially checked. Here, M indicates an interval at which an I picture frame or a P picture frame appears in a GOP. At this time, the comparison difference calculated in operation 330 is changed into a value obtained by adding (M−2) to a comparison difference between the checked VFC and the VFC of the first I picture frame.

In operation 340, if the picture frame in operation 335 is a second I picture frame or a P picture frame, the VFC of the picture frame is read and a picture frame corresponding to the VFC of the first I picture frame read in operation 325 is decoded.

In operation 345, during decoding, decoding with respect to a portion corresponding to the comparison difference calculated in operation 330 is skipped without decoding picture frames following after the first I picture frame and only the second I picture frame or the P picture frame checked in operation 335 is decoded.

In operation 350, the B picture frame corresponding to the input point of time is decoded using the reference frames decoded in operations 340 and 345 and is finally output.

In operation 360, if the picture frame in operation 320 is a P picture frame, the VFC of a past I picture frame is read to extract a past reference frame. At this time, a past I picture frame that is closest to the P picture frame is selected using index information included in the video data stream to be reproduced.

In operation 365, as in operation 340, the picture frame corresponding to the VFC of the I picture frame read in operation 360 is decoded.

In operation 370, during decoding, decoding with respect to picture frames preceding the P picture frame corresponding to the input point of time is skipped without decoding picture frames following after the I picture frame.

In operation 350, the P picture frame corresponding to the input point of time is decoded using the reference frame decoded in operation 365 and is finally output.

FIG. 4 illustrates the structure of a vop_coding_type indicating the type of a picture frame.

Referring to FIG. 4, a bitstream structure of a frame (picture) called a video object plane is illustrated. A start code is composed of 32 bits, i.e., 4 bytes, and a vop_coding_type indicating the type of a frame is composed of 2 bits. Thus, 2 bits of vop_coding_type, 00, 01, and 10 indicate an I picture, a P picture, and a B picture, respectively.

The 2 bits 00, 01, and 10 can be distinguished as follows:

vop_coding_type=(data&0xC0)>>6 (3),

where vop_coding_type indicates the type of a picture frame included in a video data stream, data indicates 1-byte data after 4 bytes from a start point of a start code of the picture frame, and 0XC0 indicates a hexadecimal hexa code of 11000000. By performing an AND operation on 0XC0 and data and performing a shift operation to the right by 6 bits, the 2 bits 00, 01, and 10 can be distinguished.

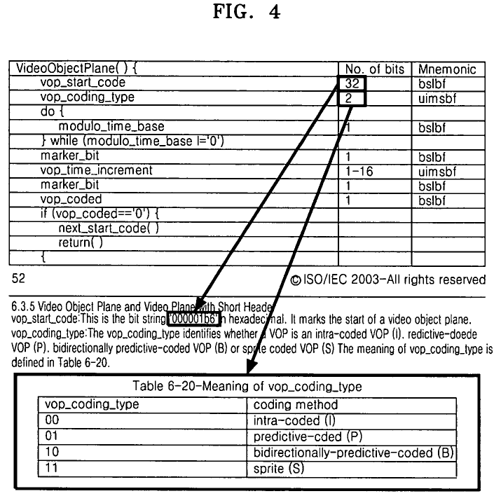

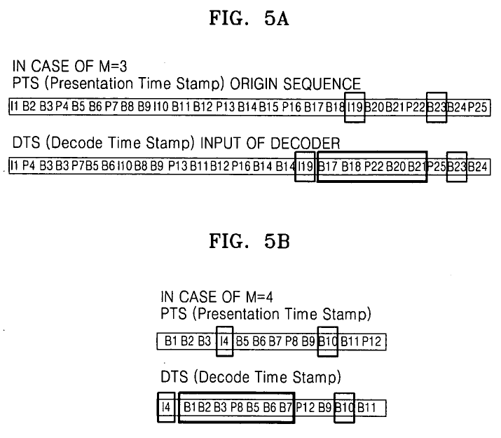

FIG. 5A is an illustration of comparing the order of picture frames in a reproducing order and the order of picture frames in a decoding order.

Referring to FIG. 5A, if M, which indicates an interval at which an I picture frame or a P picture frame appears in a GOP, is 3, two (=M−1) B picture frames are consecutively located and I picture frames or P picture frames are located at both ends of those B picture frames.

For example, if a specific picture frame corresponding to a specific point of time for output (e.g., 2 minutes and 30 seconds) is B23, the VFC of the B picture frame is 23 and the VFC of a past I picture frame (first I picture frame) that is closest to the B picture frame B23 is 19. A comparison difference between VFC+1, i.e., 24 and VFC of the first I picture frame, i.e., 19, is 5. Thus, decoding with respect to 5 picture frames after decoding of the first I picture frame can be skipped on a decode time stamp (DTS), a P picture frame P25 following after the 5 picture frames is decoded, and the B picture frame B23 is decoded using the reference frames, and is output. Since unnecessary decoding time can be reduced, the specific B picture frame can be searched for and output within a short period of time.

FIG. 5B is another illustration of comparing the order of picture frames in a reproducing order and the order of picture frames in a decoding order.

Referring to FIG. 5B, if M is 4, three (=M−1) B picture frames are consecutively located, and I picture frames or P picture frames are located at both ends of those B picture frames.

For example, if a specific picture frame corresponding to the input point of time (e.g., 2 minutes and 30 seconds) is B10, the VFC of the B picture frame is 10 and the VFC of a previous I picture frame (first I picture frame) that is closest to the B picture frame is 4. A comparison difference between a result (VFC+1=11) of adding 1 to the VFC of the B picture frame corresponding to the input point of time and the VFC(=4) of the first I picture frame is 7. Thus, decoding with respect to 7 picture frames following after the first I picture frame on a DTS can be skipped, a P picture frame P12 following after the 7 picture frames is decoded, and the B picture frame B10 is decoded using the reference frame and is output.

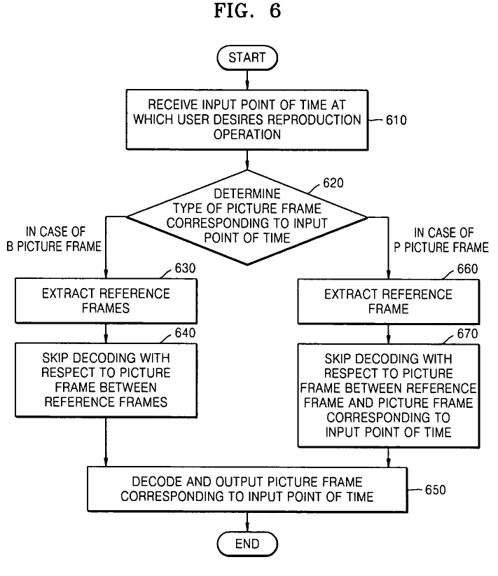

FIG. 6 is a flowchart illustrating a method of reproducing a compression-encoded video data stream according to another embodiment of the present invention.

Referring to FIG. 6, the method includes receiving an input point of time at which a user desires a reproduction operation in operation 610, determining the type of a picture frame corresponding to the input point of time in operation 620, extracting reference frames required to decode the picture frame corresponding to the input point of time if the type of the picture frame is determined to be a B frame picture in operation 630, skipping decoding for a picture frame between the reference frames in operation 640, extracting a reference frame required to decode the picture frame corresponding to the input point of time if the type of the picture frame is determined to be a P picture frame in operation 660, skipping decoding for a picture frame between the reference frame and the picture frame corresponding to the input point of time in operation 670, and decoding the picture frame corresponding to the input point of time using the extracted reference frame and outputting the decoded picture frame in operation 650.

In other words, if the type of the picture frame corresponding to the input point of time is determined to be a B picture frame in operation 620, decoding with respect to a picture frame between reference frames (an I picture and a P picture) required for decoding the B picture frame is skipped and only the reference frames are decoded, thereby decoding and outputting the B picture frame within a short period of time.

If the type of the picture frame corresponding to the input point of time is determined to be a P picture frame in operation 620, decoding with respect to a picture frame between a reference frame (I picture) required for decoding the P picture frame and the P picture frame is skipped and only the reference frame and the P picture frame are decoded and output.

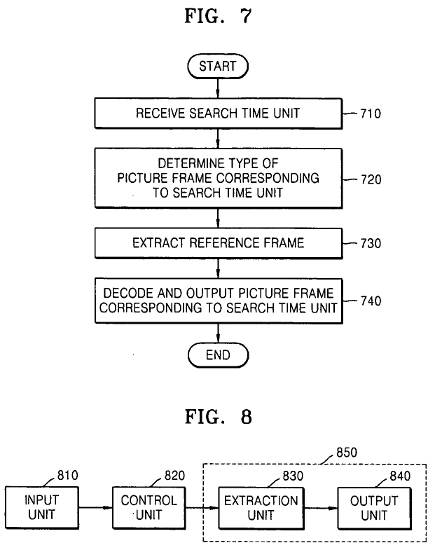

FIG. 7 is a flowchart illustrating a method of fast searching for a compression-encoded video data stream according to an embodiment of the present invention.

Referring to FIG. 7, the method includes receiving a search time unit for fast search in operation 710, determining the type of a picture frame corresponding to the search time unit in operation 720, extracting a reference frame required for decoding the picture frame corresponding to the search time unit according to the determined type of the picture frame in operation 730, and decoding the picture frame corresponding to the search time unit using the extracted reference frame and outputting the decoded picture frame in operation 740.

In operation 710, the search time unit for a fast search is received. For example, the search time unit could be input as intervals of 10 seconds, and a corresponding picture can be output and a fast search (FF, RW) performed at intervals of 10 seconds. Operations 720 through 740 are the same as operations of the method of reproducing the video data stream at a specific point of time (e.g., 2 minutes and 10 seconds, 2 minutes and 20 seconds) corresponding to the input search time unit. The search time unit can be automatically changed over search duration time. As a non-limiting example, the search time unit may gradually increase from the unit of 10 seconds to 30 seconds, 1 minute, 5 minutes, and 10 minutes.

FIG. 8 is a block diagram of an apparatus to reproduce a compression-encoded video data stream according to an embodiment of the present invention.

Referring to FIG. 8, the apparatus includes an input unit 810, a control unit 820, an extraction unit 830, and an output unit 840.

The input unit 810 receives and processes an input point of time at which a user desires a reproduction or output operation on a video data stream.

The control unit 820 calculates the VFC of a picture frame corresponding to the input point of time and determines the type of the picture frame.

The extraction unit 830 extracts a reference frame required for decoding the picture frame corresponding to the input point of time according to the determined type of the picture frame. If the type of the picture frame is determined to be a B picture frame by the control unit 820, a first I picture frame and a second I picture frame (or a P picture frame) required for decoding the B picture frame are extracted and processed.

The output unit 840 includes a decoder, decodes the picture frame using the reference frames extracted by the extraction unit 830, and displays the decoded picture frame.

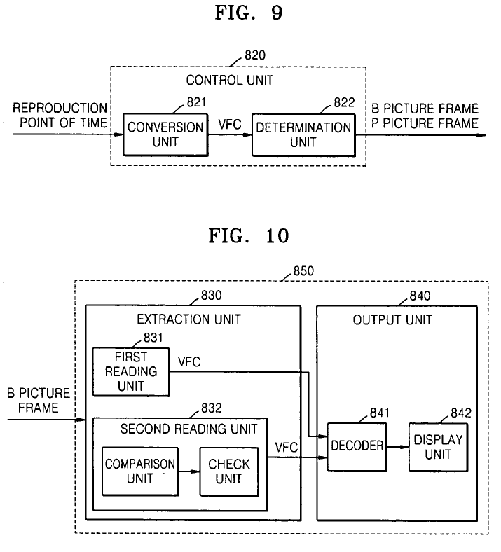

FIG. 9 is a detailed block diagram of the control unit 820 illustrated in FIG. 8 according to an embodiment of the present invention.

Referring to FIG. 9, the control unit 820 includes a conversion unit 821 and a determination unit 822. The conversion unit 821 calculates a VFC corresponding to the input point of time. Since the input point of time is expressed by a time unit (such as, for example, seconds) and the unit of processing of a system is a frame count, conversion between those units is required and is performed using Equation 1 described above.

targetVidCnt=(timeStamp*pm→ticksPerSec[pm→videoTrack]/(pm→ticksPerFrame[pm→videoTrack]*1000.0) (1),

where targetVidCnt is a VFC to be calculated, timestamp is an input point of time, pm is a program memory pointer, videoTrack is a delimiter of a currently reproduced video data stream, ticksPerSec is the number of system clock ticks per second, and ticksPerFrame is the number of system clock ticks per frame. Appropriate adjustments can be made if the time unit is smaller than seconds. For example, if the unit of the input point of time is 1/1000 second (ms), it is made identical to the unit of processing by being multiplied by 1000.0.

The input point of time undergoing the conversion is converted into the VFC of a specific picture (picture frame) corresponding to the input point of time and is transmitted to the determination unit 822.

The determination unit 822 searches for a picture frame corresponding to the input point of time among picture frames included in a video data stream and determines the type of the found picture frame. At this time, referring to FIG. 4, since the vop_coding_type indicating the type of the picture frame is composed of 2 bits, the type of the picture frame can be identified according to whether the 2 bits are 00, 01, or 10 using Equation 3 as follows:

vop_coding_type=(data&0xC0)>>6 (3),

where vop_coding_type indicates the type of a picture frame included in a video data stream, data indicates 1-byte data after 4 bytes from a start point of a start code of the picture frame, and 0XC0 indicates a hexadecimal hexa code of 11000000. By performing an AND operation on 0XC0 and data and performing a shift operation to the right by 6 bits, the 2 bits 00, 01, and 10 can be distinguished.

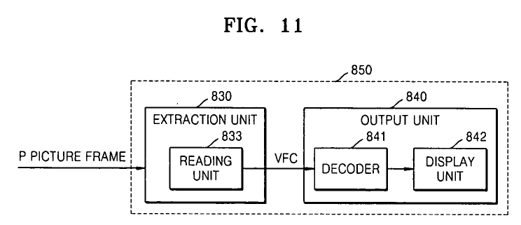

FIG. 10 is a detailed block diagram 850 of the extraction unit 830 and the output unit 840 illustrated in FIG. 8 according to an embodiment of the present invention.

Referring to FIG. 10, the extraction unit 830 may include a first reading unit 831 and a second reading unit 832. If the determination unit 822 determines that the type of the picture frame is a B picture frame, a bidirectional prediction using a macroblock in a past direction, a future direction, or both with respect to the current frame on a time axis is performed using an I picture or a P picture as a prediction picture. Thus, the first reading unit 831 reads the VFC of a past I picture frame that is closest to the B picture frame using index information included in the video data stream, and the second reading unit 832 reads the VFC of a second I picture frame or a P picture frame that is closest to the B picture frame in a decoding order of the video data stream. The second reading unit 832 may include a comparison unit for comparing a result (VFC+1) of adding 1 to the VFC of the B picture frame and the VFC of the first I picture frame and a check unit for checking if a picture frame following after the first I picture frame by the comparison difference is a second I picture frame or a P picture frame. The output unit 840 may include a decoder 841 to decode the first I picture frame, skipping decoding with respect to a portion corresponding to the comparison difference after the first I picture frame, decoding the second I picture frame or the P picture frame, and decoding a picture frame corresponding to the input point of time using the decoded reference frame, and a display unit 842 for outputting the decoded picture frame corresponding to the input point of time.

FIG. 11 is a detailed block diagram 850 of the extraction unit 830 and the output unit 840 illustrated in FIG. 8 according to another embodiment of the present invention.

Referring to FIG. 11, the extraction unit 830 may include a reading unit 833. If the determination unit 822 determines that the type of the picture frame is a P picture frame, a forward (unidirectional) prediction is used that encodes the P picture frame by interframe prediction using an I picture or a P picture as a prediction picture and uses a macroblock in a past frame of the P picture frame on the time axis. Thus, the reading unit 833 extracts the VFC of the past I picture frame. Since motion estimation in a temporal direction is not applied to an I picture frame and the I picture frame can be encoded using only information within itself, the decoder 841 to decode the I picture frame skips decoding with respect to a picture frame following after the I picture frame, and decodes the picture frame corresponding to the input point of time using the decoded reference frame. A display unit 842 displays the decoded picture frame corresponding to the input point of time.

Meanwhile, the method of reproducing a compression-encoded video data stream and the method of fast searching for a compression-encoded video data stream according to aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. Aspects of the present invention may also be embodied in computer-readable code embodied as a computer data signal in a carrier wave (e.g., a signal transmitted over the Internet). The computer-readable code embodied as a computer data signal in a carrier wave can also be distributed over network coupled computer systems so that the computer-readable code is stored and executed in a distributed fashion.

As described above, according to aspects of the present invention, a P picture frame and a B picture frame as well as an I picture frame corresponding to a specific point of time can be output and a specific picture frame can be decoded and output in a short period of time. In particular, aspects of the present invention are useful for a device for outputting a frame corresponding to a specific point of time, such as, for example, a video printer.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of reproducing a compression-encoded video data stream, the method comprising:
receiving an input point of time at which a user desires a reproduction operation;
determining the type of picture frame corresponding to the input point of time;
extracting a reference frame required to decode the picture frame corresponding to the input point of time according to the determined type of picture frame; and
decoding the picture frame corresponding to the input point of time using the extracted reference frame and outputting the decoded picture frame.

2. The method of claim 1, wherein the determining of the type of picture frame corresponding to the input point of time comprises:
calculating a video frame count (VFC) corresponding to the input point of time; and
determining the type of picture frame found by searching for the picture frame corresponding to the input point of time among picture frames included in the video data stream using the VFC.

3. The method of claim 2, wherein the calculating of the video frame count (VFC) corresponding to the input point of time comprises calculating the VFC by multiplying the input point of time by the number of system clock ticks per second and dividing the multiplication result by the number of system clock ticks per frame.

4. The method of claim 1, wherein if the type of picture frame corresponding to the input point of time is determined to be a bidirectional-predictive (B) picture frame, the extracting of the reference frame required to decode the picture frame corresponding to the input point of time according to the determined type of picture frame comprises:
reading the VFC of a past first intra (I) picture frame that is closest to the B picture frame using index information included in the video data stream; and
reading the VFC of a past second I picture frame or a predictive (P) picture frame that is closest to the B picture frame in a decoding order of the video data stream.

5. The method of claim 4, wherein the reading of the VFC of a past second I picture frame or a predictive (P) picture frame that is closest to the B picture frame in a decoding order of the video data stream comprises:
comparing (VFC+1), which is a result of adding 1 to the VFC of the B picture frame, and the VFC of the first I picture frame; and
checking if a picture frame following after the first I picture frame by the comparison difference in a decoding order of the video data stream is a second I picture frame or a P picture frame.

6. The method of claim 5, wherein if the checked picture frame is neither the second I picture frame nor the P picture frame, then checking if picture frames corresponding to VFC, (VFC−1), through to (VFC−M+2) are the second I picture frame or the P picture frame, in which M is an interval at which an I picture frame or a P picture frame appears in a group of pictures (GOP).

7. The method of claim 5, wherein the decoding of the picture frame corresponding to the input point of time using the extracted reference frame and the outputting of the decoded picture frame comprises:
decoding the first I picture frame;
skipping decoding with respect to a portion corresponding to the comparison difference after the first I picture frame and decoding the second I picture frame or the P picture frame; and
decoding the picture frame corresponding to the input point of time using the decoded reference frames and outputting the decoded picture frame.

8. The method of claim 1, wherein if the type of picture frame corresponding to the input point of time is determined to be a P picture frame, the extracting of the reference frame required to decode the picture frame corresponding to the input point of time according to the determined type of picture frame comprises reading the VFC of a past I picture frame that is closest to the P picture frame using index information included in the video data stream.

9. The method of claim 8, wherein the decoding of the picture frame corresponding to the input point of time using the extracted reference frame and outputting the decoded picture frame comprises:
decoding the I picture frame; and
skipping decoding with respect to a picture frame following after the I picture frame, decoding the picture frame corresponding to the input point of time using the decoded I picture frame, and outputting the decoded picture frame.

10. The method of claim 1, wherein if the type of picture frame corresponding to the input point of time is determined to be a B picture frame, the decoding of the picture frame corresponding to the input point of time using the extracted reference frame and outputting the decoded picture frame comprises skipping decoding with respect to a P picture frame or the B picture frame between the extracted reference frames.

11. The method of claim 1, wherein if the type of picture frame corresponding to the input point of time is determined to be a P picture frame, the decoding of the picture frame corresponding to the input point of time using the extracted reference frame and outputting the decoded picture frame comprises skipping decoding with respect to the P picture frame or a B picture frame between the extracted reference frame and the picture frame corresponding to the input point of time.

12. A method of fast searching for a compression-encoded video data stream, the method comprising:
receiving a desired unit search time;
determining the type of picture frame corresponding to the received search time unit;
extracting a reference frame required for decoding the picture frame corresponding to the unit search time according to the determined type of picture frame; and
decoding the picture frame corresponding to the unit search time using the extracted reference frame and outputting the decoded picture frame.

13. The method of claim 12, wherein the unit search time is automatically changed over a duration of search time.

14. The method of claim 13, wherein the automatically changed unit search time gradually increases.

15. A method of fast searching in a compression-encoded video data stream, the method comprising:
receiving a selected input point of time, a selected unit search time and a selected direction of search;
determining the type of picture frame corresponding to the selected input point of time;
extracting a reference frame required for decoding the picture frame corresponding to the selected input point of time according to the determined type of picture frame;
decoding the picture frame corresponding to the selected input point of time using the extracted reference frame and outputting the decoded picture frame;
calculating a new input point of time by adding or subtracting the unit search time according to the direction of search, and
repeatedly receiving a calculated input point of time, determining the type of picture frame corresponding to the calculated input point of time, extracting a reference frame required for decoding the picture frame corresponding to the calculated input point of time according to the determined type of picture frame; decoding the picture frame corresponding to the calculated input point of time using the extracted reference frame and outputting the decoded picture frame; and calculating a new input point of time by adding or subtracting the unit search time according to the direction of search until the fast searching is completed.

16. The method of claim 15, wherein the unit search time is automatically changed over a duration of search time.

17. The method of claim 16, wherein the automatically changed unit search time gradually increases.

18. An apparatus to reproduce a compression-encoded video data stream, the apparatus comprising:
an input unit to receive an input point of time at which a user desires a reproduction operation;
a control unit to determine the type of picture frame corresponding to the input point of time;
an extraction unit to extract one or more reference frames required for decoding the picture frame corresponding to the input point of time according to the determined type of picture frame; and
an output unit to decode the picture frame corresponding to the input point of time using the extracted reference frame and outputting the decoded picture frame.

19. The apparatus of claim 18, wherein the control unit comprises:
a conversion unit to calculate a video frame count (VFC) corresponding to the input point of time; and
a determination unit to determine the type of picture frame found by searching for the picture frame corresponding to the input point of time among picture frames included in the video data stream using the VFC.

20. The apparatus of claim 19, wherein the conversion unit calculates the VFC by multiplying the input point of time by the number of system clock ticks per second and dividing the multiplication result by the number of system clock ticks per frame.

21. The apparatus of claim 18, wherein the extraction unit comprises a first reading unit and a second reading unit for a bidirectional-predictive (B) picture frame such that if the type of the picture frame is determined by the control unit to be a bidirectional-predictive (B) picture frame,
the first reading unit reads the video frame count (VFC) of a past first intra (I) picture frame that is closest to the B picture frame using index information included in the video data stream; and
the second reading unit reads the VFC of a past second I picture frame or a predictive (P) picture frame that is closest to the B picture frame in a decoding order of the video data stream.

22. The apparatus of claim 21, wherein the second reading unit comprises:
a comparison unit to compare (VFC+1), which is a result of adding 1 to the VFC of the B picture frame, and the VFC of the first I picture frame; and
a check unit to check if a picture frame following after the first I picture frame by the comparison difference in a decoding order of the video data stream is a second I picture frame or a P picture frame.

23. The apparatus of claim 22, wherein if the picture frame checked by the check unit is neither the second I picture frame nor the P picture frame, the check unit sequentially checks whether picture frames corresponding to the VFC, (VFC−1), through to (VFC−M+2) are the second I picture frame or the P picture frame, in which M is an interval at which an I picture frame or a P picture frame appears in a group of pictures (GOP).

24. The apparatus of claim 22, wherein the output unit comprises:
a decoder to decode the first I picture frame, skip decoding with respect to a portion corresponding to the comparison difference after the first I picture frame and decode the second I picture frame or the P picture frame, and to decode the picture frame corresponding to the input point of time using the decoded first I picture frame and second I picture frame or the P picture frame; and
a display unit to output the decoded picture frame corresponding to the input point of time.

25. The apparatus of claim 18, wherein the extraction unit comprises a reading unit for a predictive (P) picture frame such that if the type of picture frame determined by the control unit is a P picture frame, the reading unit reads the video frame count (VFC) of a past I picture frame that is closest to the P picture frame using index information included in the video data stream.

26. The apparatus of claim 25, wherein the output unit comprises:
a decoder to decode the I picture frame, skipping decoding with respect to a picture frame following after the I picture frame, and decoding the picture frame corresponding to the input point of time using the decoded I picture frame; and
a display unit to output the decoded picture frame corresponding to the input point of time.

27. The apparatus of claim 18, wherein the extraction unit comprises a first reading unit and a second reading unit for a bidirectional-predictive (B) picture frame and a reading unit for a predictive (P) picture frame and wherein the output unit comprises a decoder and a display unit, such that
if the type of the picture frame determined by the control unit is a B picture frame,
the first reading unit reads the video frame count (VFC) of a past first intra (I) picture frame that is closest to the B picture frame using index information included in the video data stream;
the second reading unit reads the VFC of a past second I picture frame or a predictive P picture frame that is closest to the B picture frame in a decoding order of the video data stream and
the decoder decodes the first I picture frame, skips decoding with respect to a portion corresponding to the comparison difference after the first I picture frame and decodes the second I picture frame or the P picture frame, and decodes the picture frame corresponding to the input point of time using the decoded first I picture frame and second I picture frame or the P picture frame, and
if the type of picture frame determined by the control unit is a P picture frame,
the reading unit reads the video frame count (VFC) of a past I picture frame that is closest to the P picture frame using index information included in the video data stream
the decoder decodes the I picture frame, skips decoding with respect to a picture frame following after the I picture frame, and decodes the picture frame corresponding to the input point of time using the decoded I picture frame; and
wherein the display unit outputs the decoded picture frame corresponding to the input point of time.

28. The apparatus of claim 18, wherein if the type of picture frame determined by the control unit is a B picture frame, the output unit skips decoding with respect to a P picture frame or the B picture frame between extracted reference frames.

29. The apparatus of claim 18, wherein if the type of picture frame determined by the control unit is a P picture frame, the output unit skips decoding with respect to the P picture frame or a B picture frame between an extracted reference frame and the picture frame corresponding to the input point of time.

30. An apparatus for fast searching for a compression-encoded video data stream, the apparatus comprising:
an input unit to receive a desired unit search time;
a control unit to determine the type of picture frame corresponding to the received unit search time;
an extraction unit to extract a reference frame required for decoding the picture frame corresponding to the unit search time according to the determined type of picture frame; and
an output unit to decode the picture frame corresponding to the unit search time using the extracted reference frame and outputting the decoded picture frame.

31. The apparatus of claim 30, wherein the unit search time is automatically changed over duration of search time.

32. The apparatus of claim 31, wherein the automatically changed unit search time gradually increases.

33. An apparatus for fast searching for a compression-encoded video data stream, the apparatus comprising:
an input unit to receive a input point of time, a selected unit search time and a selected direction of search;
a control unit to determine the type of picture frame corresponding to the received input point of time;
an extraction unit to extract a reference frame required for decoding the picture frame corresponding to the received input point of time according to the determined type of picture frame; and
an output unit to decode the picture frame corresponding to the received input point of time using the extracted reference frame, to output the decoded picture frame, and to calculate and output to the input unit a new input point of time based on the selected unit search time and selected direction of search.

34. A computer-readable recording medium having recorded thereon a program for implementing a method of claim 1.

35. A computer data signal embodied in a carrier wave comprising a computer readable code implementing the method of claim 1.
